(19) United States
(12) Patent Application Publication
(10) Pub. No.: US 2012/0274089 A1
(43) Pub. Date: Nov. 1, 2012

(54) PORTABLE ANIMAL EXCREMENT COLLECTOR

(76) Inventor: Zak Green, Woods Cross, UT (US)

(21) Appl. No.: 13/095,858

(22) Filed: Apr. 28, 2011

(51) Int. Cl. A01K 29/00

(52) U.S. Cl. 294/1.4

(57) ABSTRACT

A manually operated portable animal excrement collector is disclosed which facilitates the even collection of animal fecal matter from the ground. Variations of the disclosed tool comprise means for gathering, enclosing, and disposing of the fecal matter with a disposable receptacle detachably affixable to the elongated tool to prevent a human operator from having to clean the tool and interact with gathered fecal matter. The present invention discloses means of manually operating a lid hingedly connected to the detachable receptacle of the tool.

### BACKGROUND OF THE INVENTION

1. Field of the Invention

This invention relates to waste collection, and more particularly relates to a portable device for gathering animal and/or pet excrement.

2. Description of the Related Art

The object of the present invention is to improve standard tools commonly available in the art for cleaning, or gathering, animal fecal matter, such as that of dogs from public park grounds. Traditional tools known in the art primarily comprise gripable, elongated clubs or rods with cup-like scoops for gathering excrement.

The conventional tools are all meant to serve the mutual goals of gathering and transporting animal excrement to a final disposal locale. Unfortunately, traditional tools usually must be cleaned after use, and do not comprise disposable excrement receptacles. Traditional tools also do not normally enclose the gathered excrement during transport, thus exposing the operator carrying to the excrement, and others around the operator, to unpleasant sights and odors.

Furthermore, traditional tools comprise cups which are pushed or dragged across the grounds in a manner which does not optimally gather all fecal matter deposited. The uneven pressure applied to fecal matter and the ground results in the fecal matter being smeared across the ground, and softer aggregate from the ground being deposited into the scoops affixed to traditional tools.

None of the tools known in the art are designed to enclose gathered fecal matter during transport, with edges to optimally gather it, or with easily disposable receptacles eliminating the need to clean and expose an operator to the gathered fecal matter.

### SUMMARY OF THE INVENTION

From the foregoing discussion, it should be apparent that a need exists for a portable animal excrement collector. Beneficially, such a tool would overcome many of the difficulties with prior art by providing a tool capable of gathering, enclosing, transporting, and easily disposing animal fecal matter.

The present invention has been developed in response to the present state of the art, and in particular, in response to the problems and needs in the art that have not yet been fully solved by currently available information management systems. Accordingly, the present invention has been developed to provide a portable animal excrement tool for applying gathering animal fecal matter, the tool comprising: an elongated shaft mounted between a cantilevered handle affixed to a proximal end of the shaft, the shaft affixed at an opposing distal end to bracket for detachably gripping a receptacle; the receptacle comprising a substantially cubic-shaped housing defining a hollow recess within, the receptacle comprising one open side, the hollow recess defined by five surfaces.

The portable animal excrement tool further comprises a second cantilevered handle affixed to an inner shaft, the inner shaft partially slidably enclosed within the proximal end of the elongated shaft, the inner shaft traversing the shaft longitudinally; the bracket affixed to the distal end of the shaft for clasping the exterior of a receptacle, the bracket comprising a plurality of prongs affixed to a rear plate at approximately right angles, the rear plate affixed to a baseplate at approximately a right angle, the baseplate affixed to the shaft; and a first slide bar hingedly affixed at one end to the inner shaft, the first slide bar comprising an elongated rigid bar, the first slide bar affixed at an opposing end to a reversing lever.

The portable animal excrement tool further comprises the reversing lever pivotably affixed at its mid-section to the shaft; a second slide bar hingedly affixed at one end to the reversing lever, the second slide bar affixed at an opposing end to a lid; and the lid hingedly connected above the open side of the receptacle, such that when the inner sleeve travels toward the distal end of the shaft, the lid is lifted open by the second slide bar affixed to the reversing lever 116.

In some embodiments, the receptacle further comprises notching along a lower edge of the open side.

In further embodiments, the lid is snappably connectably to the receptacle. In still further embodiments, the lid comprises two male snap components for fastening the lid to a portion of the receptacle comprising two female snap components.

The receptacle may further comprise groves for receiving the pluralilty of prongs. The receptacle may be transparent. The lid may further comprise a cantilevered lip detachably connected to the second slide bar.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a rear lower perspective view of the receptacle of a portable animal excrement collector in accordance with the present invention;

FIG. 2 is a front elevational perspective view of another embodiment of a portable animal excrement collector in accordance with the present invention;

FIG. 3 is a rear lower perspective view of another embodiment of a portable animal excrement collector receptacle in accordance with the present invention;

FIG. 4 is a front elevational perspective view of a portable animal excrement collector in accordance with the present invention; and

FIG. 5 is a rear lower perspective view of a portable animal excrement collector in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

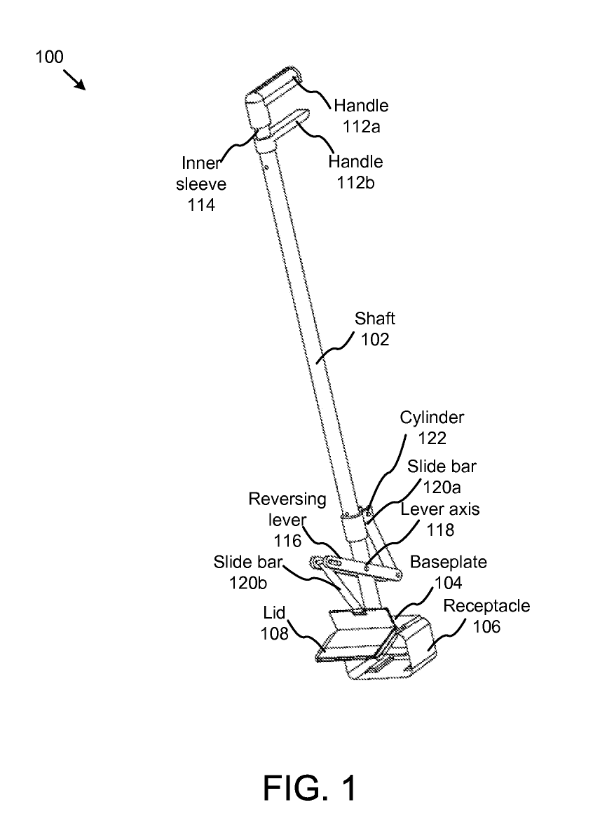

FIG. 1 is a front elevational perspective view of a portable animal excrement collector 100 in accordance with the present invention. The portable animal excrement collector 100, in the shown embodiment, comprises a shaft 102, a baseplate 104, a receptacle 106, a lid 108, a handle 112a, a handle 112b, an inner sleeve 114, a reversing lever 116, a lever axis 118, a slide bar 120a, and a slide bar 120b.

The shaft 102 comprises an elongated, hollow, tube-like member, with a distal end connected to one or more handles 112, and a proximal end connected to the baseplate 104 of a bracket.

The shaft 102 may comprise a rod, beam, stick, i-beam, h-beam, c-beam or the like. The shaft 102 may be fabricated from steel, metal alloys, polymers, wood, aluminum, titanium, and the like. The shaft 102 may be from 0.5 meters to 5 meters in length.

In some embodiments, the shaft 102 is telescopic and collapsible. In other embodiments, the shaft 102 is detachably connected to the handles 112 and/or to the bracket 202 and/or the baseplate 104. In some embodiments, the shaft 102 is partitioned, or modularized, into sub-shaft members, like tent poles, which detachably connect to form the shaft 102.

The handle 112 comprises a rigid, cantilevered protrusion from the shaft 102 (cantilevered meaning that the handle 112 juts horizontally from the shaft 102 such that the handle 112 is oriented substantially orthogonally to the shaft 102). The handle 112 is capable of being gripped by the hand(s) of human operator. In some embodiments, the handle 112 comprises a polymer grip for improving the ergonomics of the handle 112. In some embodiments, the handle 112 is affixed to the shaft 102 using means known to those of skill in the art, including screws, nails, clamps, glues, weldings, and the like.

A bracket is affixed to the bottom, or distal end, of the shaft 102. The bracket comprises a planar baseplate 104 affixed at its top plane orthogonally to the length of the shaft 102. The baseplate 104 may be fabricated from metal, polymers, wood, aluminum, and the like.

The bracket grips a receptacle 106. The receptacle 106 comprises a box-like, or cubic-shaped, housing defining a recess within it for holding animal fecal matter. The receptacle 106 is a five-sided box with one open end. The receptacle 106, in some embodiments, comprises two to three sidewalls, and/or a rear wall (i.e. back wall), a top, and bottom.

In some embodiments, the receptacle 106 is disposable. The receptacle 106 slides in and out of the bracket. The receptacle 106 may be fabricated from paper, cardboard, aluminum, plastic, or any other material commonly known in the art to be beneficial in fabricating disposable containers.

The receptacle 106 is hingedly connected at its top to a lid 108. The lid 108 open and closes over the open side of the receptacle 106. In its closed position, the lid 108 encloses fecal matter within the receptacle, ensuring that it is not smelled or seen by the human operator porting the portable animal excrement tool 100.

In the shown embodiment, an inner sleeve 114 is slidably inserted into the proximal end of the shaft 102. The inner sleeve is partially extruded from the proximal end of the shaft 102. The extruded end of the inner shaft 114 is affixed to a second cantilevered handle 112a.

Inside the shaft 102, the end of the inner sleeve 114 not affixed to the handle 112a is affixed to either the slide bar 114a, or the cylinder 122.

The cylinder 122 is affixed to the distal end of the inner sleeve 114. The cylinder 122 wraps around the shaft 102 and moves longitudinally up and down the shaft 102 as the handle 112a is inserted and withdrawn from the proximal end of the shaft 102.

The handle 112a and handle 112b are meant to be gripped together with a single hand. When gripped, and pushed together, the handle 112a slides the inner sleeve 114 further into the shaft 102 (the “closed” handle position). When the handles 112a-b are not pushed together, the tool 400 is in its “open” position.

In other embodiments, the handles 112a-b may not be cantilevered to the shaft 102. The handles 112a-b may parallel the shaft 102, or comprise rubber grips surrounding the shaft 102.

In some embodiments, the inner shaft 114 is biased toward the open position with a spring disposed within the shaft 102 between the distal end of the shaft 102 and the distal end of the inner sleeve 114. In some embodiments, the inner sleeve 114 is flexible such that curves after exiting the shaft 102 to meet the handle 112b.

The first slide bar 120a is hingedly affixed, in some embodiments, to one end to the inner shaft 114. The first slide bar 120a comprises an elongated rigid bar. The first slide bar 120a may be affixed at an opposing end to a reversing lever.

The reversing lever 116 is pivotably affixed at its mid-section to the shaft. The second slide bar 120b is hingedly affixed at one end to the reversing lever 116, the second slide bar 120b is affixed at an opposing end to the lid 108.

The lid 108 is hingedly connected above the open side of the receptacle 106, such that when the inner sleeve 114 travels toward the distal end of the shaft 102, the lid 108 is lifted open by the second slide bar 120b, which is affixed to the reversing lever 116.

The lid 108, in the shown embodiment, comprises a substantially planar rectangular member which encloses the open end of the receptacle 106. The lid 108 is affixed to a cantilevered lip jutting orthogonally from the top of the lid away from the receptacle 106. The cantilevered lip is detachably affixed to one of the slide bar 120b and a rope, such that when the slide bar 120b is forced upward, the lid 108 is hingedly forced away from the receptacle 106 such that the open end of the receptacle 106 is open.

In some embodiments of the present invention, the lid 108 is snapped with a snap fastener to the receptacle 166 (e.g. the lid is “snappable”). In these embodiments the lid 108 comprises two male snap members which engage alternative sides of the butt hinge 304, which butt hinge 304 is affixed to, and forms part of, the receptacle 106. In other embodiments, the lid 108 comprises two female snap members which receive corresponding male snap members affixed to opposing ends of the butt hinge 304.

The lid 108 may be formed from cardboard or polymers. In some embodiments, the lid 108 is formed from a transparent polymer material so that a human operator can see if the receptacle 106 is full.

The cylinder 122 is hingedly connected to the slide bar 120.

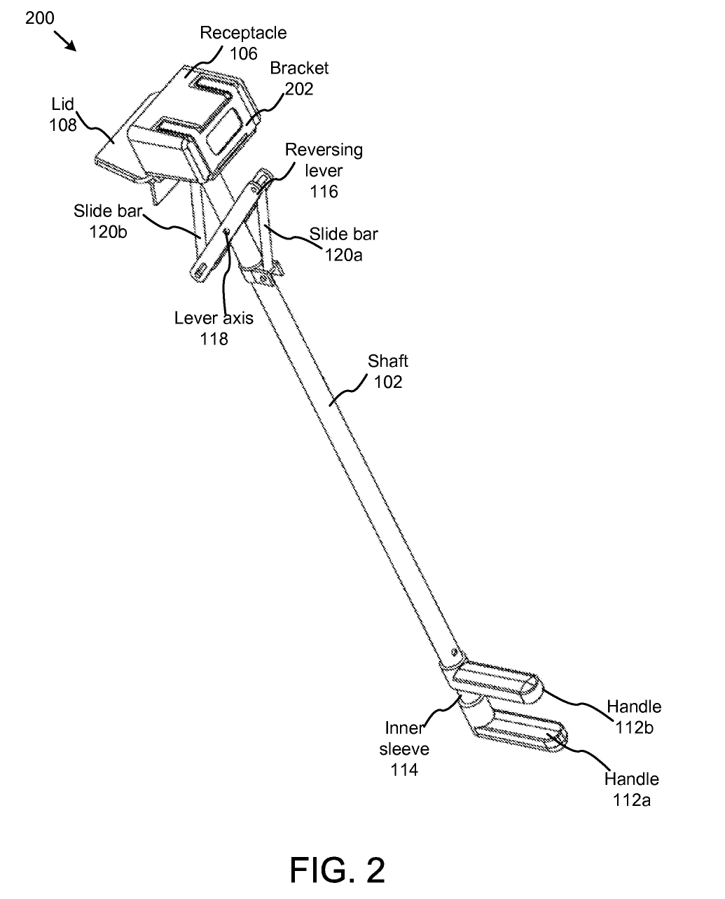

FIG. 2 is a rear lower perspective view of a portable animal excrement collector 200 in accordance with the present invention. The portable animal excrement collector 200, in the shown embodiment, comprises a shaft 102, a bracket 202, a receptacle 106, a lid 108, a handle 112a, a handle 112b, an inner sleeve 114, a reversing lever 116, a lever axis 118, a slide bar 120a, and a slide bar 120b.

Each of the components 102-120b, 202 are substantially described above in relation to FIG. 1.

The bracket 202, also described above, comprises the baseplate 104, and one or more prongs 204. The prong(s) 204 project from a rear plate affixed to the baseplate 104. The prongs 204 are affixed to the rear plate at approximately a right angle (70-402 degrees), and the rear plate is affixed to the baseplate at approximately a right angle.

Because of the shown configuration of the bracket 202, the prongs 204 and the baseplate 104 are essentially parallel and serve collectively to grip the receptacle 106 when the receptacle 106 is slid into place within the bracket 202.

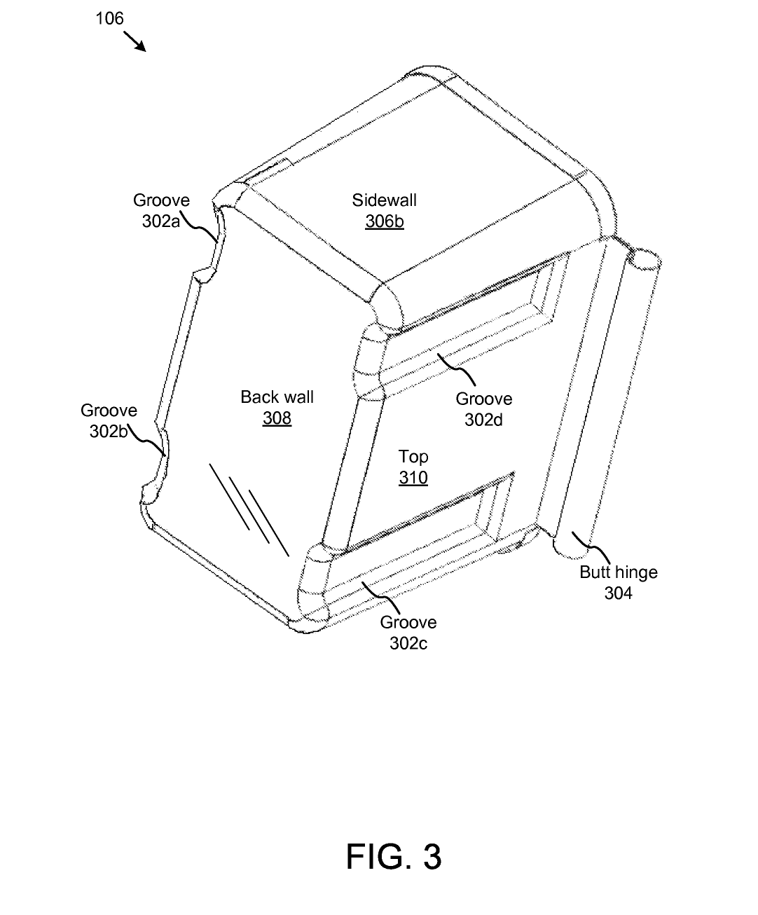

FIG. 3 is a rear lower perspective view of the receptacle 106 of a portable animal excrement collector in accordance with the present invention. The receptacle 106, in the shown embodiment, comprises four grooves 302a-d, a butt hinge 304, a sidewall 306b, a back wall 308, and a top 310.

The receptacle 106 is described above in relation to FIGS. 1-2. As shown, the receptacle 106 comprises a top 310, shown with two grooves 302c-d running from the back wall 308. The grooves 302c-d receive protrusions affixed to the bottom of the baseplate 104. The grooves 302a-d serve as tracks for the protrusions descending from the baseplate 104 and for the prongs 204.

In the shown embodiment, the open edge of the top 310 is affixed to a cydrical tube running the length of the open edge. This cylindrical tube comprises part of a butt hinge 304 used for hingedly attaching the lid 108 to the receptacle 106.

In many embodiments of the present invention, the lid 108 is detachably and hingedly affixed to the receptacle 106.

The some embodiments, the lower edge of the open side may be notched to improve the scooping efficiency of the receptacle 106.

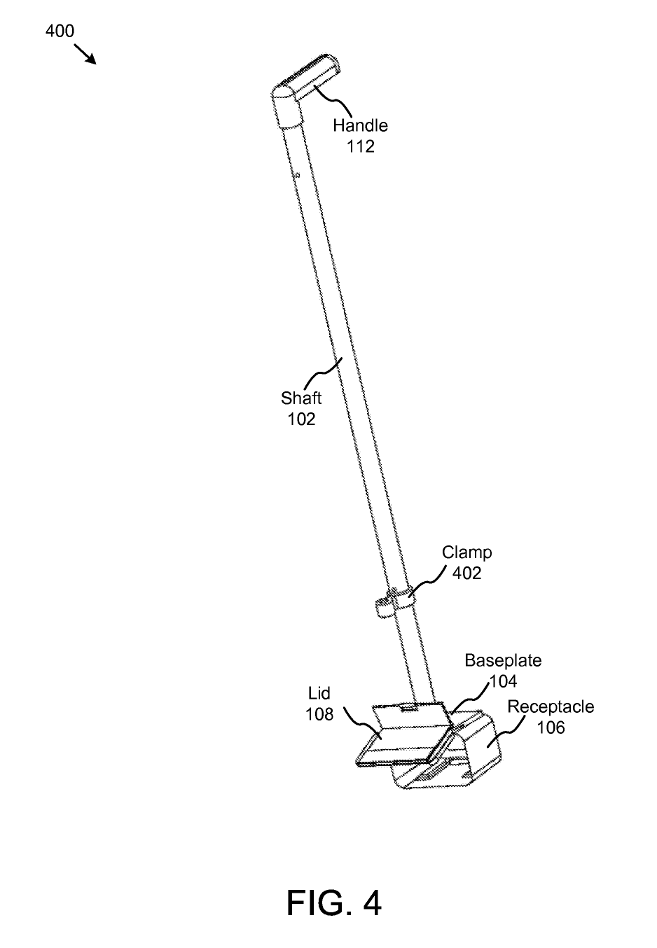

FIG. 4 is a front elevational perspective view of another embodiment of a portable animal excrement collector 400 in accordance with the present invention. The portable animal excrement collector 400, in the shown embodiment, comprises a shaft 102, a baseplate 104, a receptacle 106, a lid 108, a clamp 402, and a handle 112.

Each of the shaft 102, the bracket 202, the receptacle 106, the lid 108, the baseplate 104, and the handle 112 are substantially described above in relation to FIGS. 1-3.

The clamp 402, in some embodiments, comprises a pipe clamp affixed to a cylinder oriented parallel to the longitudinal direction of the shaft 102.

In some embodiments, a rope, string, cable, or tube is strung from the lid 108, through the clamp 402, to the handle 112. When the rope is pulled by a human operator, the lid 108 is opened for scooping up fecal matter into the receptacle 106. Other methods of activating the lid 108 are disclosed below in relation to subsequent figures.

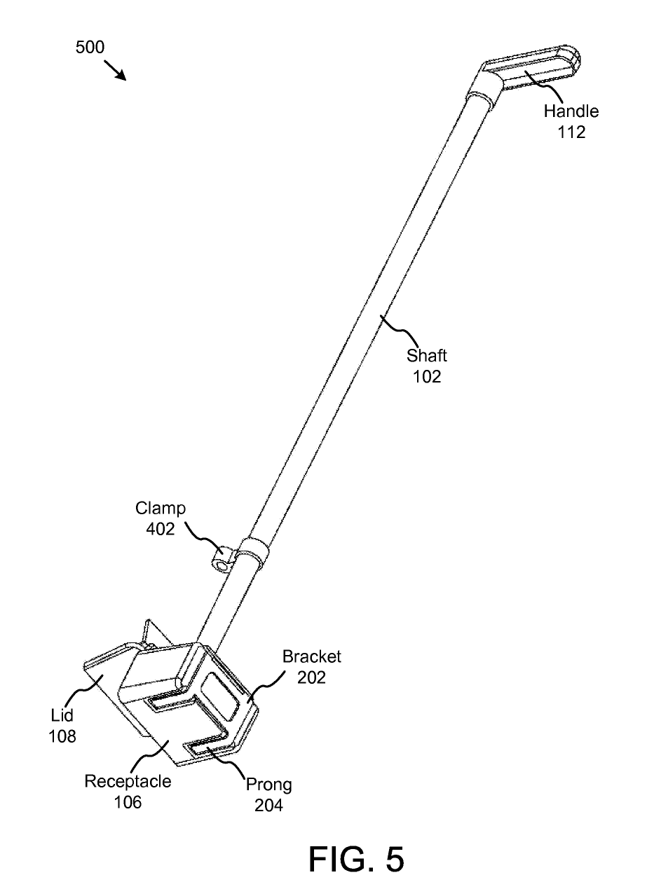

FIG. 5 is a rear lower perspective view of another embodiment of a portable animal excrement collector in accordance with the present invention. The portable animal excrement collector 500, in the shown embodiment, comprises a shaft 102, a bracket 202, a receptacle 106, a lid 108, a clamp 402, and a handle 112.

Each of the shaft 102, the bracket 202, the receptacle 106, the lid 108, the clamp 402, and the handle 112 are substantially described above in relation to FIGS. 1-4.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable animal excrement tool for applying gathering animal fecal matter, the tool comprising:
an elongated shaft mounted between a cantilevered handle affixed to a proximal end of the shaft, the shaft affixed at an opposing distal end to bracket for detachably gripping a receptacle;
the receptacle comprising a substantially cubic-shaped housing defining a hollow recess within, the receptacle comprising one open side, the hollow recess defined by five surfaces;
a second cantilevered handle affixed to an inner shaft, the inner shaft partially slidably enclosed within the proximal end of the elongated shaft, the inner shaft traversing the shaft longitudinally within;
the bracket affixed to the distal end of the shaft for clasping the exterior of a receptacle, the bracket comprising a plurality of prongs affixed to a rear plate at approximately right angles, the rear plate affixed to a baseplate at approximately a right angle, the baseplate affixed to the shaft;
a first slide bar hingedly affixed at one end to the inner shaft, the first slide bar comprising an elongated rigid bar, the first slide bar affixed at an opposing end to a reversing lever;
the reversing lever pivotably affixed at its mid-section to the shaft;
a second slide bar hingedly affixed at one end to the reversing lever, the second slide bar affixed at an opposing end to a lid; and
the lid hingedly connected above the open side of the receptacle, such that when the inner sleeve travels toward the distal end of the shaft, the lid is lifted open by the second slide bar affixed to the reversing lever.

2. The portable animal excrement tool of claim 1, wherein the receptacle further comprises notching along a lower edge of the open side.

3. The portable animal excrement tool of claim 1, wherein the lid is snappably connectably to the receptacle.

4. The portable animal excrement tool of claim 1, wherein the lid comprises two male snap components for fastening the lid to a portion of the receptacle comprising two female snap components.

5. The portable animal excrement tool of claim 1, wherein the receptacle further comprises groves for receiving the plurality of prongs.

6. The portable animal excrement tool of claim 1, wherein the receptacle is transparent.

7. The portable animal excrement tool of claim 1, wherein the lid further comprises a cantilevered lip detachably connected to the second slide bar.
